(19) United States
(12) Patent Application Publication
(10) Pub. No.: US 2011/0100265 A1
(43) Pub. Date: May 5, 2011

(54) PROCESS AND SYSTEM FOR INCREASING DENSITY OF NON-CONDUCTIVE POROUS SOLIDS AND MATERIAL MADE THEREFROM.

(76) Inventors: Philip G. Malone, Vicksburg, MS (US); Charles A. Weiss, JR., Clinton, MS (US); Sean W. Morefield, Champaign, IL (US); Vincent F. Hock, Mahomet, IL (US)

(21) Appl. No.: 12/608,422

(22) Filed: Oct. 29, 2009

(51) Int. Cl. C25B 7/00; C25D 13/02; C04B 7/46

(52) U.S. Cl. 106/746; 204/479; 204/622

(57) ABSTRACT

A “green process” and system employing a first operation of electrophoresis in a liquid suspending selected solids to introduce the suspended solid particles as micro- or nano-particles, or both, into pore spaces of a porous non-conductive medium. A second operation uses electro-transport to move ions of solids into small pore spaces inaccessible via electrophoresis alone to grow solids in these smaller pore spaces to a size that may fill them, thus increasing the density and strength of the medium. The process yields a material that has improved strength, reduced porosity, high density and, in select applications, resistance to formation of mildew, mold, fungus and the like. Certain applications also enable decorative colors and florescence to be introduced to the media. Materials made from the process include high strength concrete construction panels, “backer boards,” work surfaces, counter tops, complex decorative configurations, strong thin walled items, and the like.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Bea Shahin at 217 373-7234 or Phillip Stewart at 601 634-4113.

### BACKGROUND

Concrete-based materials have been used for protection from blasts or projectiles. Concrete is typically formed with an initial porosity related to its granular origin and the water-to-cement ratio in the concrete mixture. It has been a goal to add density and strength to concrete while reducing porosity.

Processes have been described that involve the addition of soluble carbonate compounds such as ammonium carbonate directly into a concrete or mortar mixture. For example, U.S. Pat. No. 5,624,493 teaches producing a quick-setting concrete by adding a solution of carbonate (ammonium carbonate) to a dry Portland cement mixture. The Portland cement hydrates and reacts with calcium hydroxide produced in the hydration reaction to form calcium carbonate as an additional cementing phase.

U.S. Pat. No. 6,387,174 teaches a method of forming and curing cement in a mold under high carbon dioxide density (supercritical or near supercritical) conditions.

U.S. Pat. No. 5,690,729 teaches use of carbon dioxide to reduce pH to allow use of reinforcement materials that will not tolerate high pH conditions normally produced.

What is needed is a concrete that is inexpensive to produce yet is very dense having low porosity.

### BRIEF DESCRIPTION OF DRAWINGS

FIG. 1 illustrates a configuration that may be used for completing a first step of select embodiments of the present invention.

FIG. 2 illustrates a configuration that may be used for completing a final step of select embodiments of the present invention.

### DETAILED SPECIFICATION

Select embodiments of the present invention increase the density and thus the strength of a non-conductive porous medium by filling in pores of a smaller size than would otherwise exist in the medium even after specific techniques for filling pores in the medium have been used. Select embodiments of the present invention use migration of ions in an electric field to coalesce reactants that act to produce a strong, solid phase within these smaller pore spaces otherwise not filled by conventional means. For example, the pore spaces filled by select embodiments of the present invention would not be accessible to particulate phases of material migrated by electrophoresis alone. Electrophoresis is suitable to migrate particles into larger pores within a medium to increase density, but is unsuitable for the many smaller pores.

Select embodiments of the present invention first employ electrophoresis in a suspension to introduce nano-scale solids, micro-scale solids, or both, into the pores of porous material and then employ electro-transport to move dissolved phase (ions in solution) into the porous solid to grow the solids in size to at least partially fill the pores.

Select embodiments of the present invention address disadvantages in conventional processes for increasing density of porous non-conductive materials such as Portland concrete-based materials. Select embodiments of the present invention introduce both sufficient calcium and carbonate to fill a pore completely with a newly-formed solid. Conventional processes introduce only carbonate (anion side), limiting the solids that can be produced. Also, since materials such as calcium carbonate are produced in several different polymorphs, solids that are produced by carbon dioxide cannot be controlled. Select embodiments of the present invention address this by introducing solid particles into pore spaces using electrophoresis. These solid particles may behave as “seed crystals” in the porous material being treated. As an example, one can introduce a suspension of fine-grained aragonite needles using electrophoresis as “nuclei” for later electro-transported ions needed to produce aragonite crystals in place, particularly in the smaller pore spaces un-accessible via electrophoresis alone. Aragonite, especially in its fibrous form, is a useful reinforcing material in micro-composites, and is found naturally as a major component of mollusk shells. Other solids (non-seed crystals) may comprise un-related materials such as silica fume and have no influence on the type of crystal later precipitated. Further, changes in components in the solution (electrolyte) used for ion migration, e.g., addition of traces of strontium (Sr) or cobalt (Co), influence crystal structure as well as the morphology of solid phases that form. Even small concentrations of Co and Sr interfere with formation of calcite and force crystallization of calcium carbonate as aragonite.

Select embodiments of the present invention grow reinforcement needed in a porous material directly in the pore in a second step, assuring complete pore-filling. Electrophoresis (1^{st} step) moves solids while ion migration (2^{nd} step) grows the solids to cement them into place by the growth. Since the reacting ions migrate completely through the porous solid the reinforcing process is not restricted to a surface and near-surface area. Select embodiments of the present invention should be able to migrate ions through at least two inches of conventional portland cement-based concrete or mortar.

Select embodiments of the present invention may produce very dense (less than 10% voids or pore space) concrete products using reclaimed carbon dioxide (ammonium carbonate) trapped in ammonium hydroxide-based CO₂ scrubbing systems. Conventional portland cement-based concrete has between 15-19% voids. Note that the use of ammonium carbonate as an electrolyte provides a use for a byproduct of processes used to scrub stack gas that included CO₂. This electrolyte is in a general class of materials that can be described as “green” since it sequesters CO₂. He, Q. et al., Study on Carbon Dioxide Removal from Flue Gas by Absorption of Aqueous Ammonia, Proceeding of the Third Annual Conference on Carbon Capture and Sequestration, Alexandria, Va., May 3-6, 2004. Bai, H. and A. Yeh, Removal of CO₂ Greenhouse Gas by Ammonia Scrubbing, Industrial and Engineering Chemistry Research, Vol. 36, no. 6, p. 2490-2493.

Exposing portland cement-based concrete to CO₂ normally strengthens the concrete, converting calcium hydroxide to calcium carbonate. However, this reaction shrinks the concrete while reducing its pH. CO₂ carbonation can only convert existing calcium hydroxide to calcium carbonate, and can not add pore-filling mineral phases to the concrete. Select embodiments of the present invention do not convert existing calcium hydroxide and electro-migration can be continued until the targeted media is so “non-porous” that electro-migration is not possible or, at the least extremely inefficient. All of the major constituents are non-toxic and environmentally friendly. The spent solution from the treatment containers (cells) contains ammonium acetate, which is biodegradable and can be used as a nitrogen fertilizer.

In select embodiments of the present invention a process for increasing density and strength while reducing porosity of a non-conductive porous solid includes two steps. First, electrophoresis is employed in a liquid suspension for introducing nano-scale solids, micro-scale solids, or both, into a porous solid matrix. Second, electro-transport, specifically ion-transfer in an electric field, moves ions into a porous solid to grow the solids produced from the first step to a size beneficial for increasing density and strength while reducing porosity. In select embodiments of the present invention, the above process may be repeated as needed to deposit compounds in the pores simply by renewing suspended micro- and nano-particulate solids and the diffusing solutions used at the electrodes as necessary.

In select embodiments of the present invention the cells may use an interrupted, e.g., pulsed, source. This avoids polarization of the electrodes. Further the cells may be temperature controlled and monitored to maintain a specified pH at specified positions within the cell, thus optimizing transport of the ions. For example, a current will create a higher pH at the cathode and lower the pH at the anode.

The duration required for increasing compressive strength varies as applied voltage, the composition of the medium, and its thickness. For example, it has been shown that electro-migration for chloride extraction from concrete pads of two inch (50 cm) thickness may require hundreds of hours.

Practical application of select embodiments of the present invention will require the medium, e.g., a concrete panel, to be in a vertical or near vertical position. Since a gas is generated at the electrodes, any electrode on the bottom of a horizontally placed porous non-conductive panel would have a layer of bubbles induced on the bottom surface of the panel and electrically isolate it.

Select embodiments of the present invention may provide benefits ancillary to increased compressive strength. For example, in addition to a common ammonium carbonate at the anode, one may employ a variety of carbonates, such as barium, magnesium, strontium, iron, copper, zinc, nickel and other metals. Since ammonium carbonate is the least expensive and most compatible cementing material, it would be a preferred choice if only increased compressive strength were the goal. However, if metals such as copper or zinc are used as the carbonate, the resulting dense surface would retard the growth of mold, mildew, or plants, such as English Ivy. Further, decorative effects are possible using some of these metals. For example, both silver and copper carbonates introduce color into the media while manganese-doped carbonates, lead and uranyl ions add a fluorescent component.

Select embodiments of the present invention may employ other than conventional aggregates, such as sand and crushed rock as used in conventional concrete. For example, non-conductive material such as crushed limestone or marble may be used instead of, or in addition, to sand in a portland cement-based concrete mixture. Since both of these are forms of calcium carbonate, the bond from any calcium carbonate precipitated during the electro-transport process of select embodiments of the present invention should be very strong. Sulfates, e.g., gypsum, phosphates, e.g., apatite, and other silicates and aluminates may be used in the media to which select embodiments of the present invention are applied.

Although specific applications of select embodiments of the present invention described and tested herein relate to portland cement-based media, select embodiments of the present invention will work with various non-conductive porous media, e.g., porous organic polymers, sintered glass and gypsum or calcium aluminate cement-based media and the like. Further, the media may contain non-conductive reinforcement material such as polymer fibers, glass fibers, or cellulose and the like.

Select embodiments of the present invention may be applied at ambient temperature and pressure, and are limited only by the freezing and boiling points of the solutions used for the anode and cathode electrolytes. Due to the ease of maintaining ambient pressure, there is no apparent benefit of changing the pressure. Maintaining a near neutral pH (7.0) in the range of 7.0-8.5 in select applications avoids both dissolving the carbonate that has been precipitated in the porous spaces and precipitating hydroxides of any metals. By circulating fresh solutions of electrolytes in each side, a specified pH range may be maintained since the concentration of the solution is limited by the saturation of the electrolytes. Of course, the pH of the electrolytes will be different at the anode reservoir when compared to that at the cathode reservoir.

Select embodiments of the present invention are particularly suited to producing a superior very dense pre-manufactured cement board, counter surface, work bench top, or construction siding and the like, both sealing the surface and improving compressive strength while also possibly increasing mold, mildew and fungus resistance by producing a copper or zinc carbonate as one of the pore-filling precipitates.

Although applications are shown herein with flat panels, complex shapes, such as decorative moldings having compound curves, may also be treated so long as they may be fit in an appropriately shaped treatment container (cell) allowing access of appropriate electrolytes to opposite sides of the irregularly shaped structure. Thin-walled items, such as spun-molded concrete pipe or hollow concrete statuary, may be made using select embodiments of the present invention to produce dense, strong, thin-walled concrete products of various irregular shapes.

In general, select embodiments of the present invention comprise a treatment configuration separated into two reservoirs, the configuration constructed of a non-conductive non-reactive material such as glass, ceramic, organic polymers and the like. The reservoirs are separated by the porous material to be treated, e.g., a panel of non-conducting porous material such as a concrete “backer board.” In select embodiments of the present invention a panel is inserted between the two reservoirs and sealed, e.g., with a silicon gasket bonded to the treatment configuration and situated such that the gasket fits tightly about the perimeter of the panel as it sits in the treatment configuration, establishing a seal separating the two reservoirs.

In select embodiments of the present invention, each reservoir is initially filled with the same suspension suitable for in-filling pore spaces in the porous material. For concrete backer board, a suitable suspension is calcium carbonate in mineral form. The system is then run as an electrophoretic cell to introduce particulates in the suspension into pore spaces in the porous material, e.g., particulate calcium carbonate of a specific mineralogy into pore spaces of the backer board. The suspended crystals in the suspension act as seed crystals or nuclei to promote formation of a desired mineral phase, e.g., aragonite in a needle-like form within backer board. After a suitable time, the electrophoretic process is terminated, the suspension removed and two different reactive solutions added to fill the reservoirs, one to a reservoir associated to an anode and the other to one associated to a cathode of a power source. In select embodiments of the present invention for treating a portland cement-based product, the reservoir at the anode side contains a solution of approximately 10% calcium acetate and the reservoir at the cathode side contains a solution of approximately 6% ammonium carbonate. In select embodiments of the present invention, the optimum conditions for treating a portland cement-based product also include maintaining the pH of the carbonate, typically ammonium carbonate, at approximately pH 9 and the acetate, typically calcium acetate, in the range of approximately 7 to approximately 8. In select embodiments of the present invention, the power source is selected as a DC source that impresses approximately 2 volts for every centimeter of separation of the anode from the cathode, thus for a 10 cm thick product, a 20 VDC source would be appropriate if the electrodes, preferably constructed of a durable material such as graphite, platinum and the like, were placed along the side of the product in each of the respective reservoirs. The power source is energized and the treatment configuration operated until the product reaches a specified compressive strength, density and porosity. During treatment the reservoirs are continuously replenished to maintain a specified range of concentration of the electrolyte solutions. In particular for portland cement-based products, although ammonium carbonate is a preferred “green” solution, other carbonate compounds such as sodium or potassium carbonate and the like may be used. Further, again in particular for portland cement-based products, soluble calcium compounds other than calcium acetate may be used, including compounds such as calcium nitrate, calcium chloride, calcium sulfate and the like. In select embodiments of the present invention, other compounds containing metals including such as copper, zinc, silver, barium and the like, may be added to the electrolytes, e.g., to control carbonate phase precipitates or to confer germicidal or mold, mildew and fungus resistance or even to increase mass.

However, if metals such as copper or zinc are used as the carbonate, the resulting dense surface would retard the growth of mold, mildew, or plants, such as English Ivy. Further, decorative effects are possible using some of these metals. For example, both silver and copper carbonates introduce color into the media while manganese-doped carbonates, lead and uranyl ions add a fluorescent component.

Select embodiments of the present invention provide a method for reducing porosity of a non-conductive solid having pore spaces, comprising: providing a first vessel; suspending in the first vessel the non-conductive solid; providing in the first vessel one or more first electrode pairs each electrode pair comprising a first electrode emplaced the same side of the first vessel as a first side of the non-conductive solid and a second electrode emplaced in said first vessel on the same side of the first vessel as a second side of the non-conductive solid, the second side opposing the first side of the non-conductive solid; sealing edges of the non-conductive solid within the vessel such that the non-conductive solid separates the vessel into first and second isolated reservoirs; providing in each reservoir a first liquid, the first liquid having in suspension first solids; impressing a DC voltage across each first electrode pair to introduce the first solids into the pore spaces by electrophoresis while maintaining a pre-specified concentration of suspended solids in said reservoirs for a pre-specified period; emptying said first solution from said reservoirs at the end of the pre-specified period; providing a second liquid containing suspended solids of a second type on the first side of the non-conducting solid providing a third liquid containing suspended solids of a third type on the second side of the non-conducting solid impressing a DC voltage across each electrode pair to move ions of the solids of a second and third type into the pore spaces of the porous non-conducting solid to grow the introduced first solids in the pore spaces via ion transfer in an electric field.

Select embodiments of the present invention may employ suspended solids of a first, second and third type in micro-particle form and other embodiments may employ suspended solids of a first, second and third type in nano-particle form.

Select embodiments of the present invention may employ suspended solids of a first, second and third type as micro-particles or nano-particles or combinations thereof.
Select embodiments of the present invention employ liquids of a first, second and third type that comprise diffusing electrolytes.

Select embodiments of the present invention employ suspended solids of a first, second and third type that comprise at least in part calcite.

Select embodiments of the present invention are employed to treat cured or partially cured portland cement-based products.

Select embodiments of the present invention utilize calcium ions as one dissolved cation an a type of carbonate ion as one dissolved anion.

Select embodiments of the present invention employ as one solid a calcite in treating a cured or partially cured portland cement-based mortar.

Select embodiments of the present invention provide a method for reducing porosity of a non-conductive porous solid, comprising: first employing electrophoresis in a liquid suspension incorporating one or more first solids in order to introduce the first solid into pores of the porous solid; and in a second process moving by electro-migration solid ions from reservoirs on each side of the porous solid into the pores in order to grow the deposited first solids in size.

In select embodiments of the present invention the second operation comprises ion-transfer in an electric field induced by a DC source.

Select embodiments of the present invention employ calcite as the first solids.

Select embodiments of the present invention treat cured or partially cured portland cement-based mortar.

Select embodiments of the present invention utilize cations of calcium and anions of carbonate.

Select embodiments of the present invention provide a system that facilitates reduction in the porosity of a non-conductive porous solid, comprising: a first vessel incorporating one or more pairs of first and second non-conductive reservoirs, such that each first reservoir in a pair is separated from the second reservoir in a pair by the non-conductive solid to be reduced in porosity as installed in a seal in the vessel; one electrode pair per reservoir pair, the pair comprising an anode and a cathode, such that the electrode pair operates across the non-conductive solid one electrode in each of the first and second reservoirs, and such that the anode is in the first reservoir and the cathode is in the second reservoir; one or more floats in each first reservoir and one or more floats in each second reservoir; one or more sensor suites in each first reservoir and one or more sensor suites in each second reservoir, such that each sensor suite comprises at least two sensors; one or more sources connected with each reservoir, such that each source provides a specified liquid for use in a respective reservoir; one or more conveyances between each source and a respective reservoir; and one or more control sub-systems in operable communication with at least the electrode pairs, floats, conveyances, and sensor suites.

In select embodiments of the present invention the control sub-system further comprises one or more power sources communicating with at least each electrode pair. In select embodiments of the present invention a power source comprises a DC power source. In select embodiments of the present invention a DC power source comprises a pulsed DC power source. In select embodiments of the present invention the first vessel further comprises one or more holding fixtures for affixing the porous solid in the vessel, such that the holding fixture facilitates sealing a first reservoir from a second reservoir of a reservoir pair upon insertion of the porous solid therein.

In select embodiments of the present invention the electrode pair comprises at least in part a durable material that may be: graphite, platinum, and combinations thereof.

In select embodiments of the present invention the system comprises sensor suites incorporating sensors that may be: thermometers, pH sensors, hydrometers, and combinations thereof.

In select embodiments of the present invention the system includes one or more sources comprising containers that may be: tanks, bottles, buckets, troughs, wells, pressurized containers, and combinations thereof.

In select embodiments of the present invention each of the conveyances may incorporate one or more valves communicating with one or more control sub-systems.

### Example

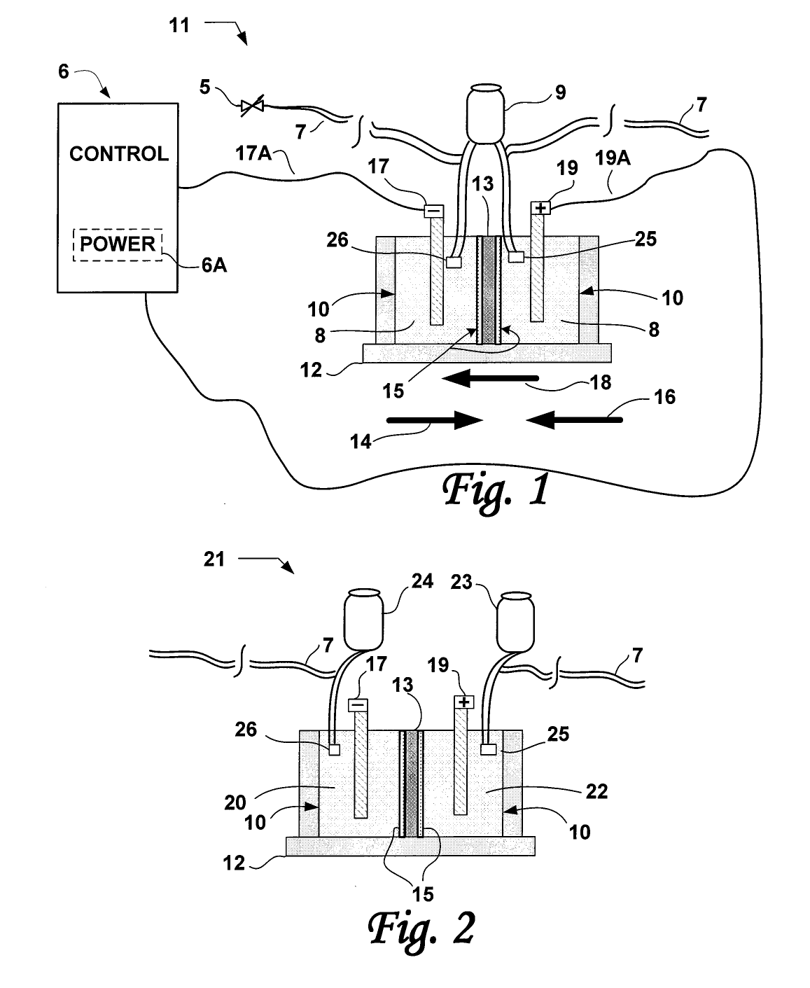

This example is merely illustrative and does not limit the scope of the invention. FIG. 1 shows a configuration 11 for completing a first step of electrophoresis in a porous panel 13, such as may comprise a cured portland cement-based mortar. The cell 12 of the configuration 11 is constructed from inert and non-conductive material, such as polyethylene, and porous non-conductive panels 13 are mounted in the cell 12 using a suitable seal 15, such as a silicone gasket or silicone cement. Electrodes 17, 19, preferably of a durable material such as graphite or platinum, are inserted in each reservoir 10 and used to apply a DC voltage (typically from about 6 to about 12 VDC, from a source such as a power supply 6A across the panel 13 from anode 19 via wire 19A from the power supply 6A to cathode 17 via wire 17A from a power supply 6A. Tests to illustrate select embodiments of the present invention employed a sample mortar panel 13 of approximately 10 mm (0.4 in) thick. Each reservoir 10 had a capacity of approximately 130 ml. For the first step employed in select embodiments of the present invention, the same liquid diffusion solution 8 is placed in each reservoir. Each reservoir 10 is filled with an aqueous solution by mixing water provided by a conveyance 7 controlled by a valve 5, typically a conduit or hose or the like, with a suitable concentrate from a first container 9. Each reservoir 10 is maintained at full capacity for the duration of the first step of the process, an electro-migration process employing a first container 9, preferably via a control valve (not shown separately) feeding the reservoirs 10 by gravity. The concentration of the diffusing solution 8 may be controlled by a combination float/sensor pad 25, 26 and a control valve (depicted only at 5 in one conveyance 7 to maintain clarity for illustration purposes) for each reservoir 10. The pads 25, 26 are connected by suitable wiring 17A, 19A to a control sub-system 6 that controls the operation of the configuration 11. In select embodiments of the present invention specifically in the first step, the first container 9 and a water supply (not shown separately) are controlled by valves 5. The reservoirs 10 are fed by conveyances 7, and the control sub-system 6 establishes and maintains the composition and amount of the resultant diffusing solution 8 in the reservoirs 10. The sensors (not shown separately for clarity) associated with the pads 25, 26 may comprise at least a pH sensor, a thermometer, a sensor, such as a hydrometer, for determining specific gravity to maintain an appropriate concentration of the diffusing solution 8, and the like. If the diffusing solution 8 in the reservoirs 10 becomes diluted, provision for adjusting the amount of the diffusing solution 8 available in the reservoirs 10 prior to adding more of the “concentrate” from the first container 9 is accomplished by the control sub-system 6.

General conditions for optimum employment of an electro-migration process in the final step of select embodiments of the present invention are such that a solution of carbonate, such as ammonium carbonate, does not become difficult to handle. Thus, electrolyte solutions are best maintained in the range of about 5% to about 10%, since as the concentration increases the mixing causes the carbonate to precipitate rapidly and the resultant precipitate is less crystallized. For concentrations of reactants greater than about 10%, amorphous calcium carbonate forms and the amorphous phase has less compressive strength than the crystallized phase. For select embodiments of the present invention, one preferred reactive solution is a 10% calcium acetate solution since it mixes well, is not viscous and is 0.63 molar. A similar (equi-molar) solution of ammonium carbonate (in the other reservoir) results in a 6% solution. Finally, for these electrolytes, the temperature must be held below 59° C. to avoid decomposing the ammonium carbonate. All experiments were run at ambient temperature (23° C.) with a suitable range being between about 10° C. and about 30° C. and a preferred range being between about 20° C. and about 23° C.

A first diffusing solution 8, such as calcium carbonate, inherently contains a useful solid phase (solid), such as calcite crystals, which can be grown from the first diffusing solution 8. This first diffusing solution 8 is continuously replenished to maintain a ready source of solid particulates for filling pore spaces in the panel 13. This diffusing solution 8 may be prepared in a form that may include solid particulates that are nano-particles, micro-particles, or both. The first diffusing solution 8 is poured into the reservoirs 10 on both sides of the panel 13. A DC voltage (source not shown separately) is established across the panel 13 that is sufficient to cause electrophoretic migration of the suspended particles (not shown separately), typically calcite crystals, toward and into the pores (not shown separately) in the panel 13. For a first diffusing solution 8 of calcium carbonate, the suspended particles may be calcite micro-particles (crystals) that have a positive charge. These calcite crystals migrate toward the cathode 17 as shown by the arrow 18, the anions moving toward the anode as shown by arrow 14 and the cations moving toward the cathode as shown by arrow 16. Suspended particles of calcite (from the container 9) are introduced into the reservoir 10 near the anode 19. The electro-phoretic migration process is continued until sufficient calcite crystals (nuclei for crystal growth) are in the pores to provide loci (or nuclei) for crystal growth. For example, for test purposes, a first diffusing suspension was prepared and placed in the reservoirs 10, yielding one to two grams of fine calcite crystals in each 130 ml reservoir 10. This was more calcite crystals than can be transferred in 20 minutes of electrophoresis. Electrophoresis was then initiated and maintained for 20 minutes. The reservoirs 10 were then emptied of this first suspension 8 without cleaning thus some calcite crystals may have remained. The reservoirs 10 were then filled with a different electrolyte 20, 22 (FIG. 2) in each reservoir 10 and any remaining calcite crystals were permitted to migrate in a subsequent four to eight hour electro-migration process employed as a final step in select embodiments of the present invention. Test results showed that migration of any remaining calcite crystals did not interfere with ion transfer occurring during the electro-migration process.

Refer to FIG. 2 in which a second configuration 21 is employed to complete the final step of the process of select embodiments of the present invention. The controls sub-system 6, valves 5 and wiring 17A, 19A, of FIG. 1 is used in this final step but omitted from FIG. 2 for improved clarity. A second diffusing solution 20, typically a carbonate, e.g., a 10% ammonium carbonate, is used to fill the reservoir 10 containing the cathode 17. The concentration of the carbonate is maintained by replenishing a carbonate concentration from a second container 24 and adjusting water amount as needed from the water source via conveyance 7 in much the same manner as was done using the pad/sensor 26 of the first step as described for FIG. 1. A third diffusing solution 22, typically an acetate, e.g., 10% calcium acetate, is used to fill the reservoir 10 containing the anode 19. The concentration of the acetate is maintained by replenishing an acetate from a third container 23 and adjusting water amount as needed from the water source via conveyance 7 in much the same manner as was done using the pad/sensor 25 of the first step as described for FIG. 1. The two reservoirs 10 containing anions (carbonate solution 20) and cations (acetate solution 22), respectively, form the solid phase desired for final filling the pore spaces in the porous panel 13. These ions are introduced so that the cation concentration is greatest at the anode 19 and the anion concentration is greatest at the cathode 17. When DC current flows across the cell 12, the cations and anions electro-diffuse (electro-transport) into the panel 13 in sufficiently high concentrations to precipitate a solid (such as calcite for a portland cement-based panel) and fill the pore spaces in the panel 13, increasing density and concomitant strength while reducing porosity.

### Test Results

A non-conducting and inert polyethylene test cell was configured with two solution reservoirs 10 separated by two different sample mortar panels 13 constructed from portland cement, each panel 13 being 10 mm thick. For each panel 13, a 10% solution 20 of ammonium carbonate in distilled water was used in the cathode 17 side and a 10% solution 22 of calcium acetate in distilled water was used in the anode 19 side. For each panel 13, a current of approximately 3-4 milliamps was maintained across the test cell 12 for four hours. A different mortar was used for each panel 13, one (PCFA) with fly ash, and one (PC) without. Both panels 13 contained 65% (mass) quartz sand and 11% (mass) water while the PCFA panel 13 contained 6% (mass) fly ash reducing the portland cement to 18% (mass) as compared to the 24% (mass) portland cement in the PC panel 13. The initial density of the PCFA panel 13 was over 5% greater than that of the PC panel 13. The density increase in the PC panel 13, when processed by a select embodiment of the present invention, was 5.6% (from 1.87 gm/cm³ to 1.98 gm/cm³) while the PCFA panel 13 experienced a density increase of only 1.0% (from 1.99 gm/cm³ to 2.01 gm/cm³). Thus, the more porous the mortar, the greater the change in density when employing select embodiments of the present invention. For this test, microphotographs showed that a mixture of calcium and carbonate ions in the smaller pore spaces precipitated calcium carbonate, permitting an increase in density not otherwise available using conventional methods.

Additional tests demonstrate strength increases when employing solutions 22, 20, respectively, of 5% calcium acetate in the reservoir 10 with the anode 19 and 10% ammonium carbonate in the reservoir 10 with the cathode 17. Sample portland cement-based mortar panels 13 with no fly ash were prepared as above but treated for 8 hours with a 6-volt potential impressed across the cell 12. The treated panels 13, together with control (untreated) panels, were cut into cubes of about 1 cm³ for testing. Test results show an increase in strength of approximately 25% when compared to the non-treated panels, i.e., the unconfined compressive strength increased from an average of about 8.24 MPa (1200 psi) to about 10.35 MPa (1500 psi). The table shows the progression based on cumulative charge. Based on this and like data, one is able to estimate the exact energy cost of increasing the strength of a structural element prior to selecting the method since the increase in strength has been established in proportion to the cumulative charge.

Increase in Compressive Strength with
Cumulative Charge through the Panel.

| | | Unconfined | Standard |
|---|---|---|---|
| | Cumulative Charge | Compressive Strength | Deviation |
| Sample | (Coulombs) | (MPa/psi) | (MPa/psi) |
| Control | 0 | 8.24/1195 | 1.5/216 |
| A | 232.3 | 7.40/1073 | 1.3/184 |
| B | 301.9 | 9.22/1338 | 2.1/300 |
| C | 511.6 | 10.35/1501 | 3.5/509 |

The maximum strength that can be obtained with select embodiments of the present invention would be that in which all of the available pore spaces are filled. A most likely candidate for achieving this theoretical maximum would be carbonate-cemented sandstone. The minimum unconfined compressive strength for conventional “well cemented sands” is approximately 19 MPa (2780 psi). With complete cementation using select embodiments of the present invention it should be possible to exceed this strength.

While the invention has been described in terms of some of its embodiments, those skilled in the art will recognize that the invention can be practiced with modifications within the spirit and scope of the appended claims. For example, a configuration may be designed to use an interrupted or pulsed current source that prevents polarization of the electrodes 17, 19. The configuration may also be temperature-controlled to establish and maintain a pH that assures optimum conditions exist for transport of the ions. It is therefore to be understood that within the scope of the appended claims, the invention may be practiced otherwise than as described.

The abstract of the disclosure is provided to comply with the rules requiring an abstract that will allow a searcher to quickly ascertain the subject matter of the technical disclosure of any patent issued from this disclosure. 37 CFR §1.72(b). Any advantages and benefits described may not apply to all embodiments of the invention.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A method for at least reducing porosity of a non-conductive solid having pore spaces, comprising:
providing a vessel;
suspending in said vessel said non-conductive solid;
providing in said vessel at least one electrode pair comprising an anode emplaced on the same side of said vessel as a first side of said non-conductive solid and a cathode emplaced in said vessel on the same side of said vessel as a second side of said non-conductive solid, said second side opposing said first side of said non-conductive solid;
sealing edges of said non-conductive solid within said vessel such that said non-conductive solid separates said vessel into first and second isolated reservoirs;
providing in each said reservoir a first liquid, said first liquid having in suspension at least some first solids;
impressing a DC voltage across each said first electrode pair to introduce said first solids into at least some said pore spaces by electrophoresis while maintaining a pre-specified concentration of suspended solids in said reservoirs for a pre-specified period;
emptying said first solution from said reservoirs at the end of said pre-specified period;
providing a second liquid containing at least some suspended solids of a second type on said first side of said non-conducting solid;
providing a third liquid containing at least some suspended solids of a third type on said second side of said non-conducting solid;
impressing a DC voltage across each said electrode pair to move ions of said solids of a second and third type into said pore spaces of said porous non-conducting solid to grow introduced said first solids in said pore spaces via ion transfer in an electric field.

2. The method of claim 1 in which said suspended solids of a first, second and third type is in micro-particle form.

3. The method of claim 1 in which said suspended solids of a first, second and third type are in nano-particle form.

4. The method of claim 1 in which the form of said suspended solids of a first, second and third type is selected from the group consisting of: micro-particles, nano-particles, and combinations thereof.

5. The method of claim 1 in which at least some of said liquids of a first, second and third type comprise diffusing electrolytes.

6. The method of claim 1 in which at least one of said suspended solids of a first, second and third type is at least in part calcite.

7. The method of claim 1 in which said porous non-conductive solid is an at least partially cured portland cement-based product.

8. The method of claim 1 in which at least one said suspended solids include at least calcium ions.

9. The method of claim 1 in which at least one said suspended solids include at least one type of carbonate ion.

10. The method of claim 1 in which at least one said solid is calcite and said porous non-conductive solid is an at least partially cured portland cement-based mortar.

11. Material produced by the method of claim 1.

12. A method for at least reducing the porosity of a non-conductive porous solid comprising:
first employing electrophoresis in a liquid suspension incorporating at least one first solid to introduce said at least one first solid into pore spaces of said porous solid; and
in a second process moving solid ions from reservoirs on each side of said porous solid into said pore spaces to grow deposited said first solids to further fill said pore spaces.

13. The method of claim 12 in which said second process comprises ion-transfer in an electric field.

14. The method of claim 12 in which said first solids comprise at least calcite.

15. The method of claim 12, said porous solid comprising cured mortar incorporating at least some Portland cement.

16. The method of claim 12 said ions comprising at least cations of calcium and anions of carbonate.

17. The method of claim 16 further incorporating in said carbonate a metal selected from the group consisting of copper, zinc, silver, barium and combinations thereof,
wherein addition of said one or more said metals facilitates retarding the growth of mold, mildew and fungus and the attachment of leafy plants.

18. The method of claim 16 further doping said carbonate to color said non-conductive porous solid, said dopants selected from the groups consisting of: silver, copper, and combinations thereof.

19. The method of claim 16 further doping said carbonate to cause said non-conductive porous solid to fluoresce, said dopants selected from the groups consisting of: manganese, lead, uranyl ions, and combinations thereof.

20. The method of claim 12 in which said first solids are in micro-particle form.

21. The method of claim 12 in which said first solids are in nano-particle form.

22. The method of claim 12 in which said first solids in which the form of said first solids is selected from the group consisting of: micro-particles, nano-particles, and combinations thereof.

23. Material produced by the method of claim 12.

24. A system for at least facilitating reduction in the porosity of a non-conductive porous solid, comprising:
a vessel incorporating at least one pair of first and second non-conductive reservoirs,
wherein, in operation, each said first reservoir in said reservoir pair is separated from said second reservoir in said pair by at least said non-conductive porous solid as installed in a seal in said vessel;
at least one electrode pair comprising an anode and a cathode, wherein a said electrode pair is in operable communication with a said pair of first and second reservoirs, and
wherein a said anode is in operable communication with a first said reservoir and a said cathode is in operable communication with a second said reservoir;
an at least one first float in operable communication with each said first reservoir and an at least one second float in operable communication with each said second reservoir;
an at least one first sensor suite in operable communication with each said first reservoir and an at least one second sensor suite in operable communication with each said second reservoir,
wherein each said first and second sensor suite comprises at least two sensors; an at least one source in operable communication with each said first and each said second reservoirs,
wherein each said at least one source provides a specified liquid for use in a respective said reservoir;
at least one conveyance between each said source and a said respective reservoir; and
at least one control sub-system in operable communication with at least said electrode pairs, said floats, said conveyances, and said sensor suites.

25. The system of claim 24, said control sub-system further comprising at least one power source in operable communication with at least each said electrode pair.

26. The system of claim 25, said at least one power source further comprising a DC power source.

27. The system of claim 26, said DC power source further comprising a pulsed DC power source.

28. The system of claim 24, said vessel further comprising at least one holding fixture for affixing said porous solid in said vessel,
wherein said at least one holding fixture facilitates sealing said first reservoir from said second reservoir upon insertion of said porous solid therein.

29. The system of claim 24, said electrode pair comprising at least in part a durable material selected from the group consisting of: graphite, platinum, and combinations thereof.

30. The system of claim 24, said at least one first and second sensor suites comprising at least sensors selected from the group consisting of: thermometers, pH sensors, hydrometers, and combinations thereof.

31. The system of claim 24 in which said at least one source further comprises containers selected from the group consisting of: tanks, bottles, buckets, troughs, wells, pressurized containers, and combinations thereof.

32. The system of claim 24, each of said conveyances further comprising at least one valve in operable communication with at least said control sub-system.
